(19) United States
(12) Patent Application Publication
(10) Pub. No.: US 2008/0061161 A1
(43) Pub. Date: Mar. 13, 2008

(54) Attachment of Components to Composite Materials

(75) Inventor: Saman Fernando, Victoria (AU)

Correspondence Address: KIRK HAHN, 14431 HOLT AVE, SANTA ANA, CA, 92705, US

(73) Assignee: GLOBAL ENGINEERED FASTENERS PTY LTD, Braeside (AU)

(21) Appl. No.: 11/572,804

(22) PCT Filed: Jul. 26, 2005
(86) PCT No.: PCT/IB05/02290

§ 371 Date: Jun. 7, 2007

(30) Foreign Application Priority Data
Jul. 26, 2004 (AU) 2004904092

(51) Int. Cl. E01B 9/18; E04B 1/41; F16B 39/00

(52) U.S. Cl. 238/321

(57) ABSTRACT

A fastening assembly for fastening a component to a concrete structure. The fastening assembly includes a plastic ferrule around and to which the concrete is cast. A threaded fastener engages the ferrule and extends from a surface of the concrete. The ferrule comprises an elongate tubular plastic body having two ends, a bore in the tubular plastic body, and at least one integral flange member extending radially outwardly from and around the tubular body at a position intermediate the ends of the tubular body for a major part of the circumference of the tubular body. The fastening assembly exhibits a resilience such that it can effectively recover from an axial load which displaces the fastener outwardly from the concrete by a distance greater than 2% of the length of the tubular body.

### FIELD OF THE INVENTION

This invention relates to fastenings which utilize ferrules embedded within composite materials. It relates particularly but not exclusively to the use of ferrules in concrete structures, particularly concrete railway sleepers (ties) and structural concrete panels, to provide attachment points for screws to secure components to the concrete. The invention has particular applicability to fastening relatively thin concrete structures, and for high vibration conditions, such as affixing railway components to concrete sleepers and to conditions requiring allowance for significant movement between components fastened together such as for structural components in earthquake-prone areas.

### BACKGROUND OF THE INVENTION

Composite materials such as steel reinforced concrete is widely used for engineered structures. Some examples are tilt-up panels for buildings and railway sleepers. Concrete sleepers for railway tracks are quite common in many parts of the world given that composite materials such as concrete in certain circumstances have advantages over the conventional product, namely wooden sleepers.

Whilst composite materials have a number of advantages, they do have the disadvantage that they are often not able to accept methods for fixing items such as railway components (eg. rails) thereto in a strong and reliable fashion with screws or nails.

Numerous fastening systems have been developed for attachment of railway rails to concrete sleepers. These usually involve rigidly attaching some form of steel attachment means to the sleeper and then resiliently clipping the rail to the attachment means. On some occasions a rigid fastener is used between the attachment means and the rail. However such systems are expensive to manufacture and install.

It is known to attach load bearing items to concrete by affixing ferrules into the concrete at the time the concrete is cast and later screwing a threaded fastener into the ferrule to attach the load bearing item. However such fasteners are known to suffer problems, particularly where the concrete is relatively thin and where a significant degree of resiliency is needed in the fastening.

There is a desire to be able to replace damaged timber railway sleepers with concrete sleepers one at a time in track without lifting the track. This requires the use of an unusually low profile concrete sleeper and a fastening system which has no components protruding above the top of the sleeper when it is slid into place under the rails from the side of the track. Existing fastening systems have been unable to provide the desired performance of strength, resilience, low cost and ease of installation. The present invention seeks to overcome these difficulties.

The present invention seeks to provide a manner of fixing items to cast composite materials such as concrete which can be used in association with separate fixing members such as screws. The invention also seeks to provide ferrules suitable for performing such a function.

### SUMMARY OF THE INVENTION

The invention provides in one aspect a method of providing a securement location for a composite material block comprising,
disposing a ferrule having an elongate tubular body with two ends at least one of which is open, in a mould,
casting composite material in the mould to cover a major proportion of the ferrule, and
allowing the composite material to set around the ferrule to immobilize the ferrule within the resultant composite material block,
wherein the ferrule is provided with at least one flange member which extends radially from and around the body at a position intermediate the ends of the body for a major part of the circumference of the body, the ferrule is provided with an internal screw thread, the outer surface of the ferrule is shaped so as to prevent rotation of the ferrule within the composite material block when a screw is screwed into the ferrule and the at least one open end of the ferrule is left open and free of composite material.

Suitably the composite material may comprise concrete.

The at least one open end may be kept free of concrete by covering it with a removable plug. Typically, the concrete may be poured into the mould so that it assumes a level at or about the same as the level of the at least one open end. Typically the concrete level will be no more than 10 mm, more preferably 5 mm from the level of the end of the ferrule.

The method of the invention may be particularly applied to casting thin panel structural concrete walls, or to concrete railway sleepers. It is more applicable to having an unusually low profile, meaning they are relatively thin (eg. down to about 100 mm) from their top to bottom faces. Where railway sleepers are concerned, they may be reinforced with reinforcing material. The reinforcing material may comprise one or more metal bars or rods. The term “bar” when used in this specification is intended to encompass “rod”. Where the reinforcing material comprises a plurality of metal bars one or more of the bars may be arranged to lie along the cast concrete sleeper in a position at or immediately above the flange of ferrules embedded in the concrete. Thus the bars may extend parallel to the length of the sleeper. The sleeper may also include one or more bars extending in the same direction in a position at or immediately below the flange. Suitably there are two bars above and two bars below each flange.

Suitably, the flange fully encircles the tubular body. The flange may be generally circular in outline for a major part of its perimeter. It may include one or more flat spots on the circumference to prevent rotation of the ferrule within the concrete railway sleeper. There may be two regions which are circular in outline and two flat spots.

In another aspect the invention may provide an integrally formed plastic ferrule for providing an attachment location in a cast composite material block, said ferrule comprising,
an elongate tubular plastic body having two ends, at least one of which is open,
a bore in the tubular plastic body communicating with said at least one open end, and
at least one integral flange member extending radially outwardly and around from the tubular plastic body at a position intermediate the ends of the tubular plastic body for a major part of the circumference of the tubular plastic body,
wherein the ferrule is shaped so as to prevent rotation of the ferrule within the cast composite material block.

The cast composite material block may comprise a concrete railway sleeper.

The ferrule may be formed of an engineering plastic such as nylon or HDPE.

The bore of the ferrule may be provided with an internal screw thread. The internal screw thread may comprise a twin start thread. The bore may include a region free of thread. The region free of thread may be provided at or near the at least one open end. The region free of thread may have a greater diameter than the region of the bore within which the thread is formed.

Preferably the diameter of the region of the bore without thread is such that it provides an interference fit with an unthreaded shank portion of the screw. This aspect may provide a watertight seal.

Suitably, the at least one flange member is generally circular with one or more flat spots to prevent rotation within the cast concrete block.

In a further aspect the invention may provide a fastening assembly for fastening a component to a concrete structure said fastening assembly including a plastic ferrule around and to which the concrete is cast, and a threaded fastener engaging the ferrule and extending from a surface of the concrete, wherein:
the ferrule comprises:
   an elongate tubular plastic body having two ends, at least one of which is open,
   a bore in the tubular plastic body communicating with said at least one open end, and
   at least one integral flange member extending radially outwardly from and around the tubular plastic body at a position intermediate the ends of the tubular plastic body for a major part of the circumference of the tubular plastic body,
the fastener extends through said open end and the thread on the fastener engages the bore, and
the fastening assembly exhibits a resilience such that it can effectively recover from an axial load which displaces the fastener outwardly from the concrete by a distance greater than 2% of the length of said tubular body.

Preferably the fastening assembly exhibits a resilience such that it can effectively recover from an axial load which displaces the fastener outwardly from the concrete by a distance greater than 3% of the length of said tubular body.

Suitably, the ferrule is constructed so as to be able to co-operate with screws having thread forms of the general type described in applicant's co-pending Australian application 2003200362. By this cross reference all disclosures in the said co-pending application are considered to be incorporated in this specification.

Preferred aspects of the invention will now be described with reference to the accompanying drawings.

### BRIEF DESCRIPTION OF THE DRAWINGS

FIG. 1 is an illustration showing a fastening screw carrying a thread for use in a first embodiment of the present invention;

FIG. 2 is a side view of a ferrule for use in accordance with said first embodiment of the invention;

FIG. 3 is a cross section taken through the plane A-A shown in FIG. 2;

FIG. 4 is a plan view of the ferrule of FIG. 2;

FIG. 5 is an illustration showing a fastening screw carrying a thread for use in a second embodiment of the invention;

FIG. 6 is a side view of a ferrule for use in accordance with the second embodiment;

FIG. 7 is a cross section taken through the plane B-B shown in FIG. 6;

FIG. 8 is a plan view of the ferrule of FIG. 6;

FIG. 9 is a diagram showing in detail the threadform on the screws shown in FIGS. 1 and 5;

FIG. 10 shows a perspective view of a rail and sleeper assembly incorporating an embodiment of the invention;

FIG. 11 shows the cross section C-C taken through FIG. 10;

FIG. 12 shows a cross section similar to FIG. 11 taken when the concrete sleeper of FIG. 10 is being cast; and

FIG. 13 is a graph showing results from testing various fastening systems.

### DETAILED DESCRIPTION OF PREFERRED EMBODIMENTS

In the drawings the use of common numbers to identify features denotes equivalent features between embodiments.

Referring to FIG. 1, the fastening screw 2 is one which may typically be used to secure a rail or other rail component to a concrete railway sleeper which incorporates cast-in ferrules according to the invention. The screw 2 has a head 4, flange 6, plain shank 11, tapered shoulder 12 and tip 13. Between the shoulder 12 and tip 13 the screw has a portion into which a thread 15 is rolled.

For the embodiment shown, the screw has the following approximate dimensions:

| | |
|---|---|
| total length = | 130-135 mm |
| diameter of shank 11 = | about 19 mm |
| pre-roll diameter for thread 15 = | about 17.5 mm |
| diameter of flange 6 = | about 46 mm |
| head = | about 21 mm diameter 6-lobe head |

The flange 6 is tapered, with its top face 8 perpendicular to the major axis 17 of the screw and its bottom face 9 angled at about 11.5° to the top face. This taper is to conform with the corresponding taper on the foot of railway rails which the bottom face 9 bears against in use. The screws may be used to affix a rail with or without the use of a tie plate between the rail and sleeper.

The thread 15 has a 5 mm pitch and 10 mm lead. Accordingly it is a twin start thread with two ridges 21 and 31 of equal height helically winding around a core 19. The thread is continuous for its length on the screw. The crest 26 of each ridge 21 and 31 carries a pair of peaks 27 and 28 along its length and these will now be described.

With reference to FIG. 9, the threadform is indicated as the solid line in the illustration. It should be noted that the cross section through the thread 15 so illustrated is not parallel to the axis 17 of the screw, but is instead at the helix angle to the axis 17 in order to be at right angles to the line of the ridges 21 and 31. The illustration shows the twin start thread 15 consisting of identical of ridges 21 and 31 respectively which are separated by roots 23 where the thread rolling process has pressed most deeply into the metal of the shank 14. The distance of the roots 23 from the axis 17 defines the radius of the core 19 of the threaded shank 14.

Working from the left side of FIG. 9, the threadform profile rises from a root 23 to the ridge 21 by way of a flank 24 which rises to a crest 26. This crest carries two peaks 27 and 28 with a trough 29 between them. From peak 28 the ridge falls down a flank 25 to the root 23 which is of the same depth as the root on the other side of the ridge 21. The threadform then repeats its sequence for ridge 31. Ridges 21 and 31 are the two ridges which together form the twin-start thread 15.

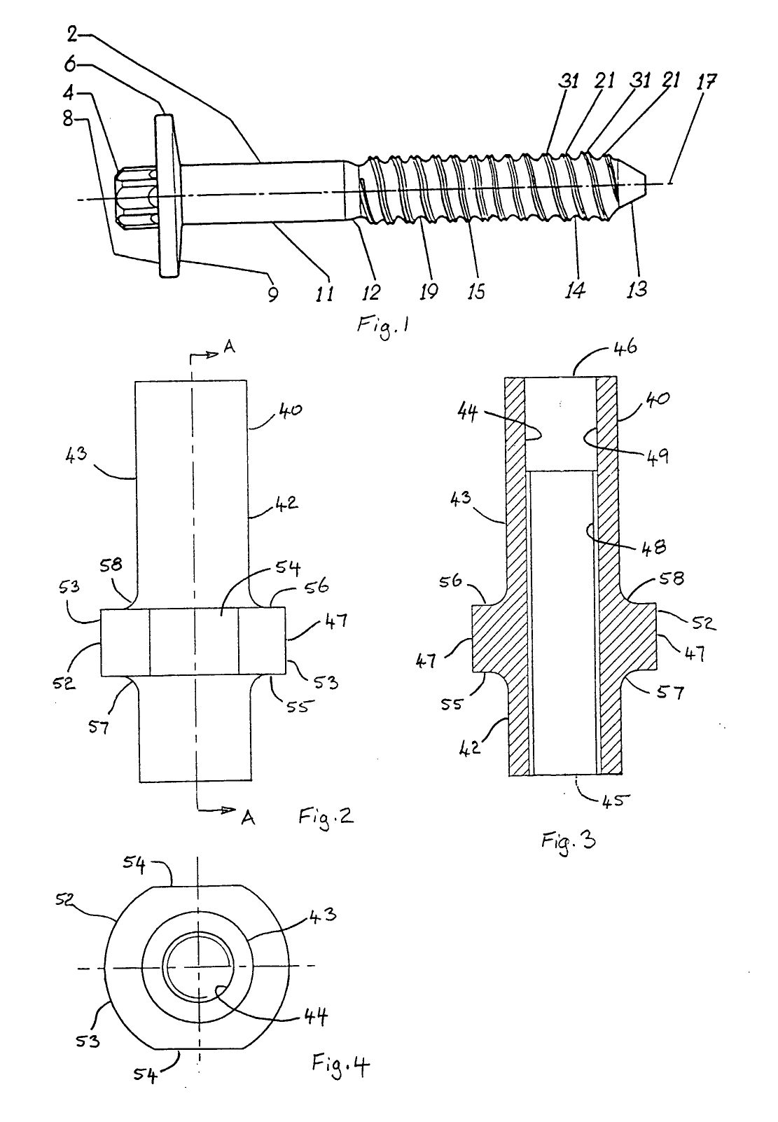

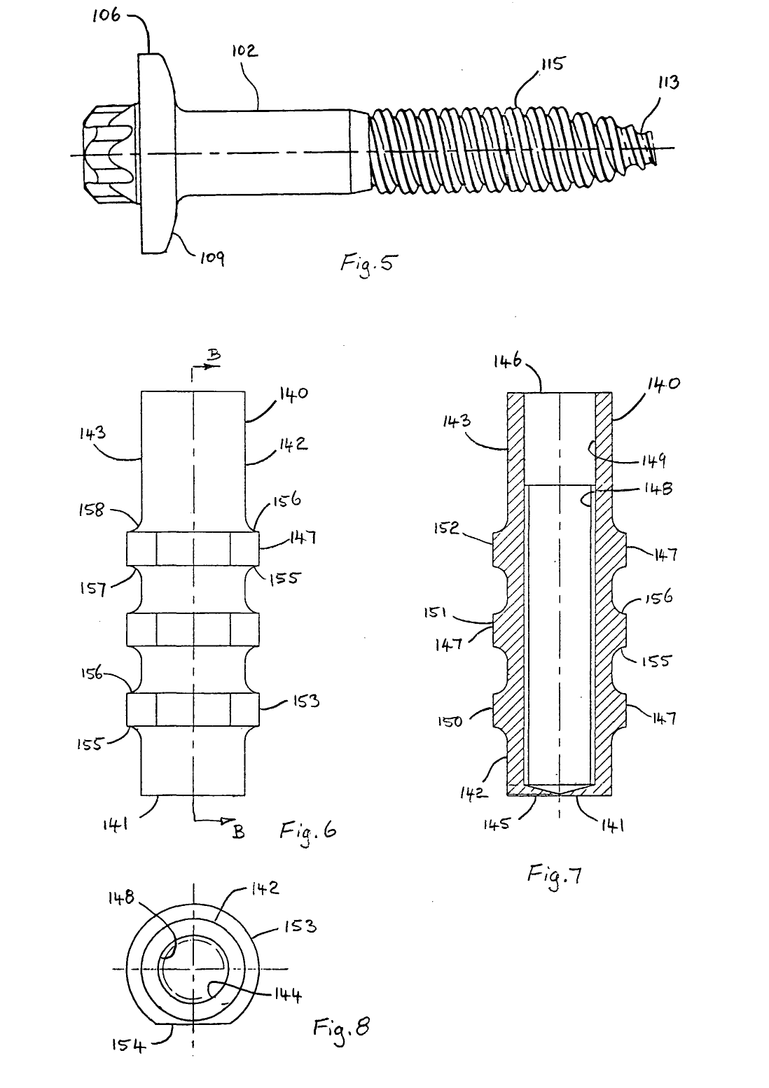

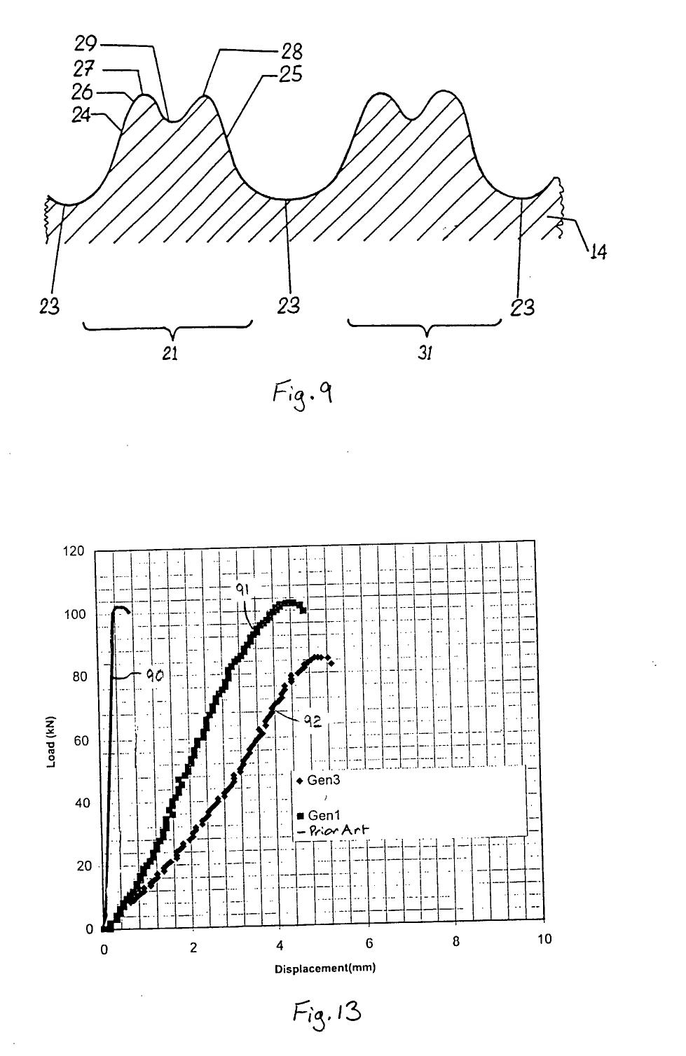

Referring to FIGS. 2 to 4, there is shown a ferrule 40 formed of an engineering plastics material which is suitable for applications requiring high strength. Typically, the ferrule would have been manufactured by an injection moulding or machining process. The material of the ferrule 40 may comprise any suitable engineering plastic such as nylon or HDPE. The preferred material properties of the ferrule are as follows:

| | |
|---|---|
| Yield Tensile Strength | 60-100 MPa |
| Elongation at Yield | greater than or equal to 20% |
| Maximum service temperature | Not less than 80° C. |
| IZOD impact notched resistance | 0.6-1 J/cm |

The ferrule 40 is integrally formed as a one piece unit. It comprises a tubular body 42 having a bore 44 with open ends 45 and 46. Whilst the ferrule illustrated is shown as having two open ends, it is to be appreciated that the lower of the open ends, namely open end 45, may instead be closed off to prevent the ingress of dirt and/or concrete during the casting process to be described hereinafter.

The major part of the bore 44 of the ferrule is provided with a twin start thread 48 shaped so as to co-operate with the threaded shank 14 of the fastening screw previously described with reference to FIGS. 1 and 9. The female twin start thread 48 is formed with an outside diameter, inside diameter and crest shape that matches that of the screw 2. However the thread in the ferrule has a pitch which is a little shorter than the corresponding thread of threaded shank 14, so that when the fastening is put under load in use, the stresses experienced by the material in the ferrule are more evenly distributed in order to increase the overall load at which the resulting construction would fail. The pitch of the thread 48 in the ferrule is preferably between 0.5% and 5% shorter than the thread 15 on the screw. More preferably it is between 1% and 4% shorter.

A thread free region 49 above the thread 48 has a wider diameter than the bore represented by the threaded part of the ferrule to accommodate the plain shank 11 of the fastening screw.

A circumferential flange 52, integrally formed with the tubular body 42, is provided intermediate the ends of the ferrule, but closer to the lower end 45 than to the upper end 46. It is located about mid-way along that portion of the ferrule which is threaded.

The peripheral surface 47 of the flange 52 has two regions defined by cylindrical faces 53 and two regions defined by diametrically opposed flat faces 54. The purpose of incorporating the flat faced portions of the circumferential flange is to prevent rotation of the ferrule when it is immobilized in cast concrete and a fastening screw is screwed into it.

The flange 52 has a pair of flat annular faces 55 and 56 on its lower and upper sides respectively. The faces 55 and 56 are perpendicular to the screw axis 17 and blend into the generally cylindrical outer wall 43 of the tubular body 42 by way of large radiused corners 57 and 58 respectively. The outer corners 59 of the faces 55 and 56 are not significantly radiused as the relatively sharp corners serve to reduce the tensile stresses induced into the surrounding concrete when the subsequent fastening is put under load.

A fastening according to the first embodiment is particularly suitable when the screw can engage the ferrule for a relatively large distance below the level of the flange 6. Without this feature the ferrule tends to fail by tensile failure across the ferrule immediately above the flange. However, if the flange 6 is placed too high on the ferrule, the fastening tends to fail by the concrete failing.

The fastening screw 102 shown in FIG. 5 has a similar form to the screw in FIG. 1 but with some significant differences. One difference is that the bottom face 109 of the flange 106 is convexly curved in order to provide an optimal contact with a range of rails having different taper angles on their feet. Another difference is that the tip 113 carries a 30° taper upon which the thread 115 is continued. The threadform on screw 102 is the same as that described earlier with reference to FIG. 9.

Referring now to FIGS. 6 to 8, the ferrule 140 shown has some significant differences from the ferrule 40 described earlier. The bottom end 145 is closed and this provides the advantage that it prevents entry of concrete material during the casting operation. The internally formed twin-start thread 148 is as described for ferrule 40. The major difference between the ferrules 40 and 140 is the size, number, shape and positioning of the external flanges.

The outer wall of the ferrule 140 carries three integrally formed circumferential flanges 150, 151 and 152 which are evenly spaced along that portion of the ferrule which is threaded.

The flanges each have a single peripheral region defined by a cylindrical face 153 and a single region defined by a flat faces 154. The flat faces 154 prevent rotation of the ferrule in the concrete when a fastening screw is screwed into the ferrule.

The flanges 150, 151 and 152 do not extend as far out as does flange 52. Their walls 155 and 156 on their lower and upper sides respectively do not include flat portions. The walls 155 and 156 blend into the generally cylindrical outer wall 143 of the tubular body 143 by way of large radiused corners 157 and 158 respectively. The walls 155 and 156 meet the peripheral surfaces 147 of the flanges at right angles to the surfaces 147 but then immediately commence to curve away into the corners 157 and 158. The outer corners 159 of the walls 155 and 156 are not significantly radiused.

Typical dimensions of a ferrule 140 to suit a 19 mm nominal diameter screw 102 would be:

| | |
|---|---|
| Total length: | 110 mm |
| Length of thread-free region 149: | 25 mm |
| Length of thread 148: | 82 mm |
| Outside diameter of body 142: | 28 mm |
| Internal diameter of thread-free region 149: | 19 mm |
| Outside diameter of flanges: | 36 mm |
| Width of flanges at tip: | 9 mm |
| Separation between flanges at tip: | 13 mm |

For the ferrule, the ratio of body outside diameter to mean thread diameter is:
R1=28/17.5=1.6

This is significantly greater than previously used fastening systems. Preferably for the present invention R1 is at least 1.4 and more preferably at least 1.5.

The minimum wall thickness between the crest of the fastener thread and the outer wall 143 is given by:
T1=(28−19)/2=4.5 mm

This is significantly greater than previously used fastening systems of this general type. Preferably for the present invention T1 is at least 3.5 mm and more preferably at least 4.0 mm.

Preferably the flange width at the tip is greater than 6 mm and less than 13 mm. Preferably the distance of separation between the flanges at their tips is greater than 6 mm and less than 13 mm.

Referring to FIGS. 10 to 12, there is shown a rail assembly 60 comprising a concrete sleeper 61 which is reinforced with steel reinforcing bars 62 running lengthwise through the concrete matrix 63 of which the concrete sleeper is formed. It should be noted that a plurality of the steel bars are placed so that they lie close to the region above and below the flange 52 of the ferrule 40.

The rail assembly 60 includes a steel rail 65 which sits on a cushioning pad 66. Typically the cushioning pad may comprise a rubber or plastic pad. The rail 65 is secured to the concrete sleeper 61 using a fastening screw 2 screwed into the ferrule 40 with the flange 6 of the screw bearing down on the foot 67 of the rail.

As is shown more clearly in FIG. 11, the ferrule 40 which has been embedded in the concrete matrix of the sleeper 61 allows access of the screw to the bore 44 of the ferrule through the open end 46. In FIG. 11, the level of the open end of the ferrule is shown as being slightly lower than the concrete level 70 of the sleeper. Generally speaking, the level of the end of the ferrule will be at or near the level of the top face of the concrete sleeper. Typically any minor difference in levels will be between 0 and 10 mm, more preferably between 0 and 5 mm. It is even possible that the end of the ferrule could protrude slightly (eg. 0.5 mm above the level of the concrete).

Referring to FIG. 12, the sleeper 61 is being cast upside down and it can be seen that the ferrule 40 can be immobilized in the concrete matrix during the process of casting the concrete sleeper. In a typical operation, plugs 82 and 81 may be fitted into the open ends 45 and 46 of the ferrule to close off the ends during the casting process in this regard the plug 81 is being used as a locating agent for the ferrule by virtue of the fact that it is fitted through an opening 83 in the bottom of the mould 40 in which the concrete sleeper is cast. The opening 83 is located so that the ferrule sits centrally in the mould and a head 84 provided on the plug acts to secure the plug 81 within the opening 83.

The ferrule 40 shown in FIG. 12 has both ends open as described for ferrule 40 earlier in this specification. In FIG. 12, the bottom end 45 has been closed off by a plug 82. As the ferrule 140 of the second embodiment is formed with a closed end, there would be no need for the plug 82. The illustration in FIG. 11 shows a ferrule 141 which is a modified form of ferrule 40 which includes a closed end 145. A small thickness of concrete matrix 69 extends between the closed end 145 and the bottom of the concrete sleeper.

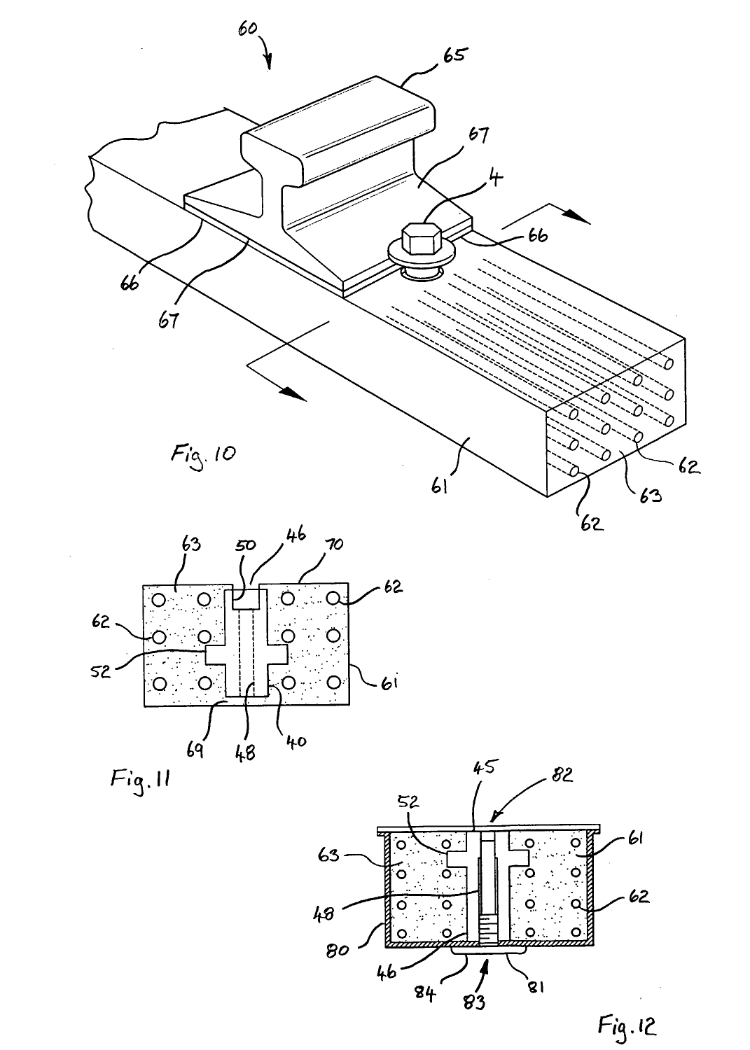

FIG. 13 shows three load-displacement curves; one each for three different arrangements for fastening a screw fastener into a concrete panel 115 mm thick. The assemblies were subjected to testing by simple withdrawal loading.

Curve 90 was achieved by a prior art fastening assembly having a plastic ferrule cast into concrete and a 19 mm nominal diameter screw fitted into it. The ferrule had a relatively thin wall in accordance with the thinking to date of those skilled in the art A relatively stiff fastening resulted. There was relatively little strain in the structure (about 0.4%) before the fastening failed due to stripping of the plastic thread.

Curve 92 was achieved by a fastening system as described for the first embodiment in this specification. The joint was more flexible and a slightly higher ultimate strength was achieved. The displacement of 4.4 mm corresponded to about 4% of the length of the ferrule. Failure occurred due to tensile failure of the ferrule just above the flange.

Curve 94 was achieved by a fastening system as described for the second embodiment in the specification. The joint is even more flexible than for the first embodiment and the displacement at maximum load corresponds to about 5% elongation of the ferrule. The maximum load was somewhat less than for curves 90 and 92 but is still satisfactory for the purpose. Failure occurred due to cracking of the concrete.

The ability of the invention to provide adequate ultimate strength and to tolerate substantially higher strain before failure is a major advantage.

The fastening system of the present invention has demonstrated a remarkable degree of resilience. The term resilience is generally meant to be the amount of displacement, when under load, that is fully recovered when the load is removed. It therefore relates to the elastic displacement of the fastening and the substantially linear portions of the curves in FIG. 13.

The peripheral surfaces of the flanges 151, 152 and 153 are tubular. This means that when the fastening is axially loaded the plastic surfaces 151, 152 and 153 may separate from the concrete and allow more favourable load distributions.

Factors which may contribute to the demonstrated high degree of resilience include:
the high ratio of body outside diameter to mean thread diameter,
the high minimum wall thickness between the crest of the fastener thread and the outer wall of the ferrule,
the plurality of flanges each having axially aligned peripheral surfaces, and
the relatively long lead (over 50% of the outside diameter) of the thread on the threaded fastener, coupled with the particular threadform.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge in Australia.

1-11. (canceled)

12. A fastening assembly for fastening a foot of a railway rail to a concrete sleeper in a railway track, said fastening assembly including a plastic ferrule around and to which the concrete forming the sleeper is cast, and a threaded fastener engaging the rail foot and the ferrule, wherein:
the ferrule comprises:
an elongate tubular plastic body having two ends, at least one of which is open,
a bore in the tubular plastic body communicating with said at least one open end, and
at least one integral flange member extending radially outwardly from and around the tubular plastic body at a position intermediate the ends of the tubular plastic body for a major part of the circumference of the tubular plastic body,
the fastener extends through said open end of the ferrule and the thread on the fastener engages the bore, and
the fastening assembly exhibits a resilience such that it can effectively recover from an axial load which displaces the fastener outwardly from the concrete by a distance greater than 2% of the length of said tubular body.

13. The fastening assembly of claim 12 which exhibits a resilience such that it can effectively recover from an axial load which displaces the fastener outwardly from the concrete by a distance greater than 3% of the length of said tubular body.

14. The fastening assembly of claim 1 wherein the outer surface of the ferrule is shaped so as to prevent rotation of the ferrule within the concrete when the threaded fastener is screwed into the ferrule.

15. The fastening assembly of claim 2 wherein the outer surface of the ferrule is shaped so as to prevent rotation of the ferrule within the concrete when the threaded fastener is screwed into the ferrule.

16. The fastening assembly of claim 1 wherein the flange member fully encircles the tubular body.

17. The fastening assembly of claim 2 wherein the flange member fully encircles the tubular body.

18. The fastening assembly of claim 16 wherein the flange member is generally circular in outline for a major part of its perimeter but with at least one flat spot on the perimeter to prevent rotation of the ferrule within the concrete.

19. The fastening assembly of claim 17 wherein the flange member is generally circular in outline for a major part of its perimeter but with at least one flat spot on the perimeter to prevent rotation of the ferrule within the concrete.

20. The fastening assembly of claim 18 wherein the perimeter has a plurality of flat spots thereon to prevent rotation of the ferrule within the concrete.

21. The fastening assembly of claim 19 wherein the perimeter has a plurality of flat spots thereon to prevent rotation of the ferrule within the concrete.

22. The fastening assembly of claim 1 wherein the bore of the ferrule is moulded with an internal screw thread.

23. The fastening assembly of claim 2 wherein the bore of the ferrule is moulded with an internal screw thread.

24. The fastening assembly of claim 22 wherein the bore of the ferrule includes a region free of thread at or near the at least one open end.

25. The fastening assembly of claim 23 wherein the bore of the ferrule includes a region free of thread at or near the at least one open end.

26. The fastening assembly of claim 22 wherein the thread in the ferrule has a pitch which is between 0.5% and 5% shorter than the pitch of the thread on the threaded fastener.

27. The fastening assembly of claim 23 wherein the thread in the ferrule has a pitch which is between 0.5% and 5% shorter than the pitch of the thread on the threaded fastener.

28. The fastening assembly of claim 26 wherein the thread in the ferrule has a pitch which is between 1% and 4% shorter than the pitch of the thread on the threaded fastener.

29. The fastening assembly of claim 27 wherein the thread in the ferrule has a pitch which is between 1% and 4% shorter than the pitch of the thread on the threaded fastener.

30. The fastening assembly of claim 1 wherein during casting of the concrete the at least one open end of the ferrule is kept free of concrete by covering said at least one open end with a removable plug.
